(19) United States
(12) Patent Application Publication
(10) Pub. No.: US 2008/0175388 A1
(43) Pub. Date: Jul. 24, 2008

(54) Control system and multicast communication method

(75) Inventors: Nobuo OKABE, Musashino-shi (JP); Shoichi SAKANE, Musashino-shi (JP); Kazunori MIYAZAWA, Musashino-shi (JP); Kenichi KAMADA, Musashino-shi (JP)

Correspondence Address: Edwards Angell Palmer & Dodge LLP, P.O. Box 55874, Boston, MA, 02205, US

(73) Assignee: Yokogawa Electric Corporation, Tokyo (JP)

(21) Appl. No.: 11/986,862

(22) Filed: Nov. 27, 2007

(30) Foreign Application Priority Data
Nov. 27, 2006 (JP) 2006-318584

(51) Int. Cl. H04L 9/06

(52) U.S. Cl. 380/277

(57) ABSTRACT

A control system includes: a plurality of field equipments that are connected mutually to an IP network; a key management server that is connected mutually to the IP network and issues key information for authentication of the plurality of field equipments and security communication; and an attribute server having a GCKS server function, which is connected mutually to the IP network, and manages or provides attribute information for mutual authentication between the field equipments, and contains preset group information for multicast communication in a particular multicast group, wherein each of the field equipments is operable to: make authentication of the key management server; acquire information of the attribute server existing on the IP network; register information of each of the field equipments itself in the attribute server; acquire startup information from the attribute server; receive a notification of the group information from the attribute server; participate in a particular multicast group using the GCKS server function; receive a distribution of secret information from the GCKS server function; and perform multicast communication based on the group information and the secret information.

This application is based on and claims priority from Japanese Patent Application No. 2006-318584, filed on Nov. 27, 2006, the entire contents of which are hereby incorporated by reference.

### BACKGROUND OF THE INVENTION

1. Technical Field

The present disclosure relates to a control system for performing control of field equipments and, more particularly, to a control system and a multicast communication method capable of performing secure multicast communication using the IP network.

2. Background Art

The following documents relate to the control system and the multicast communication method for performing the control of field equipments in the related-art.

Japanese Unexamined Patent Document 1: JP-A-11-127197,

Japanese Unexamined Patent Document 2: JP-A-2000-031955,

Japanese Unexamined Patent Document 3: JP-A-2002-094562

Japanese Unexamined Patent Document 4: JP-A-2003-258898

Japanese Unexamined Patent Document 5: JP-A-2005-135032

Japanese Unexamined Patent Document 6: JP-A-2005-210555

FIG. 7 is a configurative block diagram showing an example of a control system in the related-art. In FIG. 7, numerals 1 and 2 denote a field equipment group including a plurality of field equipments such as a sensor, an actuator, etc. equipped in the field such as the plant, or the like respectively, 3 and 4 denote a controller for controlling respective field equipments respectively, 5 and 6 denote a control terminal having a man-machine interface equipped in the field such as the plant, or the like respectively, 7 denotes an information terminal for managing information of the overall control system.

Also, numerals 100 and 101 denote a field network for connecting mutually the field layer such as “FOUNDATION Fieldbus (registered trademark)”, or the like as the Non-IP (Internet Protocol) network respectively, 102 denotes a control network for connecting mutually the control layer as the IP network of Transmission Control Protocol/Internet Protocol (TCP/IP), or the like, and 103 denotes an information network for connecting mutually the information layer as the IP network of Transmission Control Protocol/Internet Protocol (TCP/IP), or the like.

Respective field equipments constituting the field equipment group 1 are connected mutually to the controller 3 via the field network 100. Similarly, respective field equipments constituting the field equipment group 2 are connected mutually to the controller 4 via the field network 101.

The controllers 3 and 4 are connected mutually to the control network 102, and also the control terminals 5 and 6 are connected mutually to the control network 102. Also, the control terminals 5 and 6 are connected mutually to the information terminal 7 via the information network 103.

Next, an operation in the related-art as shown in FIG. 7 will be explained briefly hereunder. When respective field equipments have a measuring function such as a sensor, or the like, they provide measured information such as temperature, pressure, or the like to the upper controller via the field network 100, or the like. When respective field equipments have a driving function such as an actuator, or the like, they drive a valve, or the like in compliance with a command received from the controller via the field network 100, or the like.

The controllers 3 and 4 control the plant based on the information given by executing a predetermined program, control respective field equipments in compliance with a control command received from the upper control terminals 5 and 6 via the control network 102, or the like.

Also, the information terminal 7 acquires information of the overall control system via the information network 103 and manages the acquired information.

In the related-art shown in FIG. 7, the field network is the non-IP network, and respective field equipments are connected directly to the upper controllers. Therefore, a range of multicast communication or broadcast communication between the field equipments is limited.

For example, in the related-art shown in FIG. 7, the number of members in the multicast communication or broadcast communication per group is almost 10. The number of groups is increased as a scale of the control system is increased.

Therefore, it is considered that such restriction in the multicast communication or broadcast communication between the field equipments should be solved by constructing the field network based on the IP. FIG. 8 is a configurative block diagram showing another example of such control system according to the related-art.

In FIG. 8, numerals 3, 4, 5, 6, 7 and 103 denote the same elements as those in FIG. 8. Also, numerals 8 and 9 denote a field equipment group constructed by a plurality of field equipments such as a sensor, an actuator, etc. equipped in the field such as the plant, or the like respectively, and a numeral 104 denotes a control/field network for connecting mutually the field layer and the information layer as the IP network such as TCP/IP, or the like.

Respective field equipments constituting the field equipment groups 8 and 9 are connected mutually to the control/field network 104. Similarly, the controllers 3 and 4 and the control terminals 5 and 6 are connected mutually to the control/field network 104. Also, the control terminals 5 and 6 are connected mutually to the information network 103, and also the information terminal 7 is connected mutually to the information network 103.

Next, an operation of the related-art shown in FIG. 8 will be explained briefly hereunder. In the related-art shown in FIG. 8, since the non-IP field networks are put together in the IP network in the control layer (the control/field network 104), the multicast communication or broadcast communication is given as the full IP multicast communication.

As a result, because the non-IP field networks can be put together in the IP network in the control layer, the multicast communication, or the like can be carried out without limitations such as a range of multicast communication or broadcast communication between the field equipments on the non-IP field networks, and the like.

Also, FIG. 9 is a configurative block diagram showing still another example of the control system in the related-art, where the field network set forth in “Patent Literature 5” is set up based on Internet Protocol.

In FIG. 9, a numeral 10 denotes a key management server (KDC: Key Distribution Center) for issuing key information necessary for the authentication of the field equipment, the security communication, and the like, 11 denotes an attribute server for managing/providing attribute information (identifier, IP address, etc.) necessary for the mutual authentication between the field equipments, 12 denotes a Dynamic Host Configuration Protocol (DHCP) server for assigning the IP address dynamically in starting the field equipment, 13 and 14 denote a controller for controlling the field equipment respectively, 15, 16, and 17 denote a field equipment such as a sensor, an actuator, or the like equipped in the field such as the plant, or the like respectively, and 105 denotes an IP network.

The key management server 10, the attribute server 11, and the DHCP server 12 are connected mutually to the IP network 105. Also, the controllers 13 and 14 and the field equipments 15, 16, and 17 are connected mutually to the IP network 105.

Next, an operation in the related-art shown in FIG. 9 will be explained with reference to FIG. 10 hereunder. FIG. 10 is an explanatory view explaining the secure starting sequence of the field equipment.

The field equipment (e.g., the field equipment 15) started at (1) in FIG. 10 searches the information such as an identifier, an IP address, or the like of the key management server 10 existing on the IP network 105 from the DHCP server 12 to acquire the information.

Then, at (2) in FIG. 10, the field equipment 15 performs authentication of the key management server 10 using the acquired information such as the identifier, the IP address, or the like of the key management server 10. Also, at (3) in FIG. 10, this field equipment 15 searches the information such as an identifier, an IP address, or the like of the attribute server 11 existing on the IP network 105 to acquire the information.

Here, the communication at (2) in FIG. 10 and at (3) in FIG. 10 is the security communication secured by a Kerberos authentication. In order to clarify that the communication is held as the security communication, a symbol “locked lock” and characters “Kerberos” are affixed to the communications at (2) in FIG. 10 and at (3) in FIG. 10.

Finally, at (4) in FIG. 10, the field equipment 15 registers information of the field equipment 15 itself such as an identifier, an IP address, or the like in the attribute server 11. Also, this field equipment 15 acquires necessary startup information from the attribute server 11.

Also, the communication at (4) in FIG. 10 is the security communication in which the packet is encrypted and authenticated based on IPsec (IP security). In order to clarify that the communication is held as the security communication, a symbol “locked lock” and characters “IPsec” are affixed to the communication at (4) in FIG. 10.

As a result, according to the related-art shown in FIG. 9, the started field equipment executes the Kerberos authentication by using the key management server 10, and registers information of the field equipment itself in the attribute server and acquires the startup information from the attribute server. Thus, a secure startup of the field equipment can be realized.

In this case, the security of the multicast communication in the control system shown in FIG. 8 and FIG. 9 is not mentioned.

In contrast, the architecture applied to hold securely the multicast communication is defined in RFC3740 (The Multicast Group Security Architecture).

FIG. 11 is an explanatory view explaining the secure multicast communication. Here, a symbol “locked lock” is affixed to the security communication, and a symbol “unlocked lock” is affixed to the ordinary communication.

In FIG. 11, GCKS (Group Controller/Key Server: referred simply to as a “GCKS server” hereinafter) indicated by “GS01” is the server that executes the control necessary for the secure multicast communication. This GCKS server provides mainly five functions given as follows.

(1) Key Distribution
To distribute secret information (encryption key, encryption algorithm, and the like) necessary to preserve a secret of communication.

(2) Member Revocation
To revoke the membership of the multicast group.

(3) Re-Key
To update the secret information (encryption key, encryption algorithm, and the like) by using “Key distribution”.

(4) Registration
A certain node (field equipment) participate in a certain multicast group.

(5) Deregistration
A certain node (field equipment) secedes from the multicast group on its own initiative. Accordingly, “Member revocation” is executed.

The field equipment indicated by “FE01” in FIG. 11 on the transmitter side takes part in the particular multicast group by using “Registration” in the GCKS server indicated by “GS01” through the security communication indicated by “SC01” in FIG. 11. Also, this field equipment receives a distribution of the secret information necessary to secure a secret of communication by using “Key distribution” (referred simply to as “secret information” hereinafter).

Also, at this time, “Multicast group information” such as the IP multicast address, and the like as the group information necessary for the multicast communication in the particular multicast group indicated by “MG01” in FIG. 11 is set in the field equipment indicated by “FE01” in FIG. 11 on the transmitter side through the communication indicated by “NS01” in FIG. 11.

Meanwhile, the field equipment indicated by “FE02” in FIG. 11 on the receiver side takes part in the particular multicast group using “Registration” in the GCKS server indicated by “GS01” in FIG. 11 through the security communication indicated by “SC02” in FIG. 11. Also, this field equipment receives a distribution of the secret information necessary to secure a secret of communication by using “Key distribution” (referred simply to as “secret information” hereinafter).

Also, at this time, “Multicast group information” such as the IP multicast address, and the like as the group information necessary for the multicast communication in the particular multicast group indicated by “MG01” in FIG. 11 is set in the field equipment indicated by “FE01” in FIG. 11 on the receiver side through the communication indicated by “NS02” in FIG. 11.

Then, the field equipment indicated by “FE01” in FIG. 11 on the transmitter side sends the security communication using the secret information accepted by a distribution indicated by “SC03” in FIG. 11 to the acquired IP multicast address indicated by “MG01” in FIG. 11. Thus, this field equipment can hold the multicast communication with the field equipment indicated by “FE02” in FIG. 11 on the receiver side.

As a result, the multicast communication in the control system can be carried out securely by using the architecture defined in “RFC3740 (The Multicast Group Security Architecture)” shown in FIG. 11 and used to hold securely the multicast communication.

However, in the architecture used to hold securely the multicast communication as shown in FIG. 11, it has not been defined yet that “Multicast group information” such as the IP multicast address, and the like as the group information necessary for the multicast communication in the particular multicast group should be set in the secure communication.

Therefore, in order to ensure the security, “Multicast group information” must be set to individual field equipments through the secure communication by using any approach, or “Multicast group information” must be set to individual field equipments by the manual operation.

However, in the case of the large scale control system, the number of field equipments comes up to tens of thousands and also the number of multicast groups is increased up to a several thousand scale. There have been the problems such that it is difficult to set “Multicast group information” by the manual operation and it is feared that a risk of false setting is increased.

Therefore, in order to achieve the above-described problems, the present invention provides a control system and a multicast communication method, capable of performing secure multicast communication using the IP network.

### SUMMARY OF THE INVENTION

According to a first aspect of the present invention, a control system comprises:

a plurality of field equipments that are connected mutually to an IP network;

a key management server that is connected mutually to the IP network and issues key information for authentication of the plurality of field equipments and security communication; and

an attribute server having a GCKS server function, which is connected mutually to the IP network, and manages or provides attribute information for mutual authentication between the field equipments, and contains preset group information for multicast communication in a particular multicast group, wherein each of the field equipments is operable to:

a) make authentication of the key management server;

b) acquire information of the attribute server existing on the IP network;

c) register information of each of the field equipments itself in the attribute server;

d) acquire necessary startup information from the attribute server;

e) receive a notification of the group information from the attribute server;

f) participate in a particular multicast group by the GCKS server function;

g) receive a distribution of secret information by the GCKS server function; and

h) perform multicast communication based on the group information and the secret information.

According to a second aspect of the present invention, a control system comprises:

a plurality of field equipments that are connected mutually to an IP network;

a key management server that is connected mutually to the IP network and issues key information for authentication of the plurality of field equipments and security communication;

an attribute server that is connected mutually to the IP network and manages or provides attribute information for mutual authentication between the field equipments, and contains preset group information for multicast communication in a particular multicast group; and

a GCKS server connected mutually to the IP network, wherein each of the field equipments is operable to:

a) perform authentication of the key management server;

b) acquire information of the attribute server existing on the IP network;

c) register information of each of the field equipments itself in the attribute server;

d) acquire necessary startup information from the attribute server;

e) receive a notification of the group information from the attribute server;

f) participate in a particular multicast group by the GCKS server;

g) receive a distribution of secret information from the GCKS server; and

h) perform multicast communication based on the group information and the secret information.

According to a third aspect of the present invention, it is preferable that the multicast communication may be performed between the field equipments, between controllers for controlling the field equipments, or between the field equipment and the controller

According to a fourth aspect of the present invention, a multicast communication method causes a field equipment to perform operations comprising:

a) performing authentication of a key management server;

b) acquiring information of an attribute server existing on an IP network;

c) registering information of the field equipment itself in the attribute server;

d) acquiring necessary startup information from the attribute server;

e) receiving a notification of group information which is necessary for the multicast communication in a particular multicast group from the attribute server;

f) participating in a particular multicast group by a GCKS server function;

g) receiving a distribution of secret information by the GCKS server function, and

h) performing multicast communication based on the group information and the secret information.

According to a fifth aspect of the present invention, a multicast communication method causes a field equipment to perform operations comprising:

a) performing authentication of a key management server;

b) acquiring information of an attribute server existing on an IP network;

c) registering information of the field equipment itself in an attribute server;

d) acquiring necessary startup information from the attribute server;

e) receiving a notification of group information from the attribute server;

f) participating in a particular multicast group by a GCKS server;

g) receiving a distribution of secret information from the GCKS server; and

h) performing multicast communication based on the group information and the secret information.

According to a sixth aspect of the present invention, it is preferable that the multicast communication may be performed between the field equipments, between controllers for controlling the field equipments, or between the field equipment and the controller.

According to a seventh aspect of the present invention, a field equipment storing a program for executing a method comprising:

a) performing authentication of a key management server;

b) acquiring information of an attribute server existing on an IP network;

c) registering information of the field equipment itself in the attribute server;

d) acquiring startup information from the attribute server;

e) receiving a notification of group information which is necessary for the multicast communication in a particular multicast group from the attribute server;

f) participating in the particular multicast group using a GCKS server function;

g) receiving a distribution of secret information from the GCKS server function, and

h) performing multicast communication based on the group information and the secret information.

According to the present invention, following advantages can be achieved.

According to the first, third and fifth aspects of the present invention, the attribute server notifies the started field equipment of the group information together with the startup information, and thus is able to set the group information in the field equipment through the secure communication. Also, the attribute server controls the multicast communication using the GCKS server function provided therein, and thus is able to perform the secure multicast communication using the IP network.

Also, according to the second, third and fifth aspects of the present invention, the attribute server notifies the started field equipment of the group information together with the startup information, and thus is able to set the group information in the field equipment through the secure communication. Also, the attribute server controls the multicast communication by the GCKS server, and thus is able to hold the secure multicast communication using the IP network.

### BRIEF DESCRIPTION OF THE DRAWINGS

FIG. 1 is a configurative block diagram showing an embodiment of a control system according to the present invention;

FIG. 2 is an explanatory view explaining a secure starting sequence of a field equipment;

FIG. 3 is an explanatory view explaining a secure multicast communication;

FIG. 4 is a configurative block diagram showing another embodiment of the control system according to the present invention;

FIG. 5 is an explanatory view explaining the secure starting sequence of the field equipment;

FIG. 6 is an explanatory view explaining the secure multicast communication;

FIG. 7 is a configurative block diagram showing an example of a control system in the related-art;

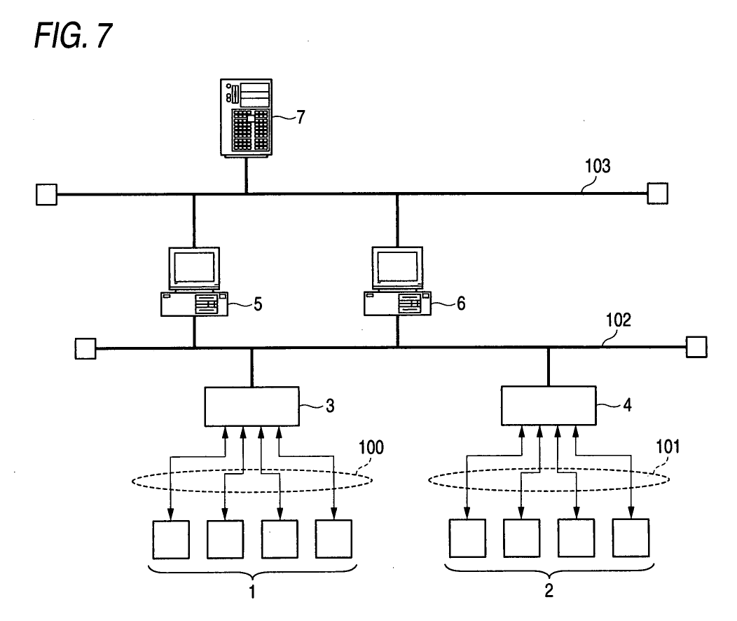

FIG. 8 is a configurative block diagram showing another example of a control system in the related-art;

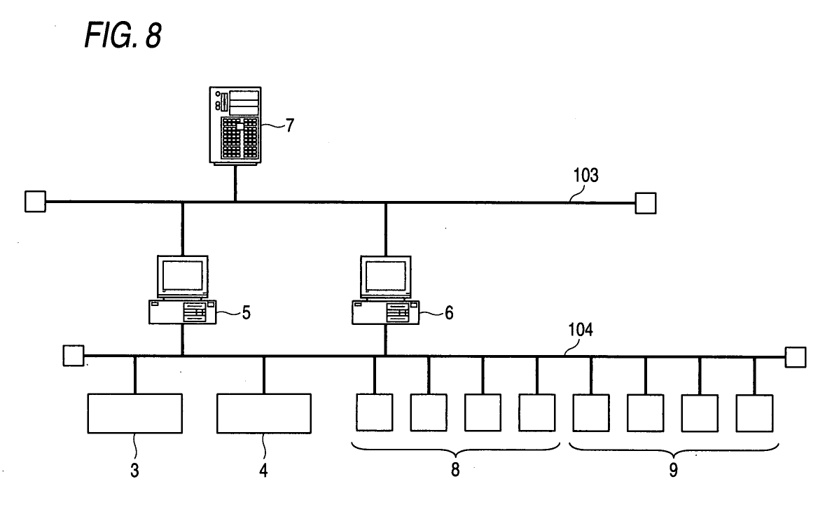

FIG. 9 is a configurative block diagram showing still another example of a control system in the related-art;

FIG. 10 is an explanatory view explaining the secure starting sequence of the field equipment; and

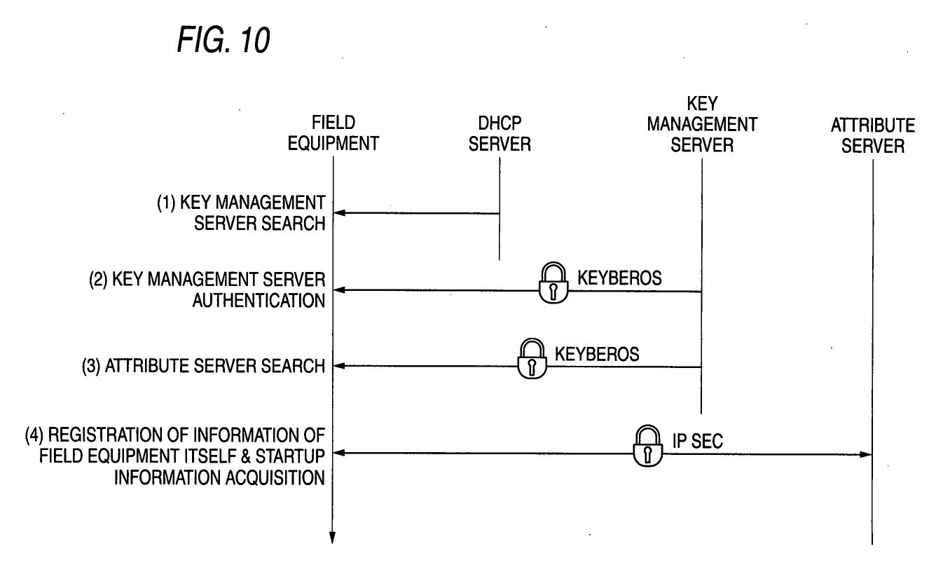

FIG. 11 is an explanatory view explaining the secure multicast communication.

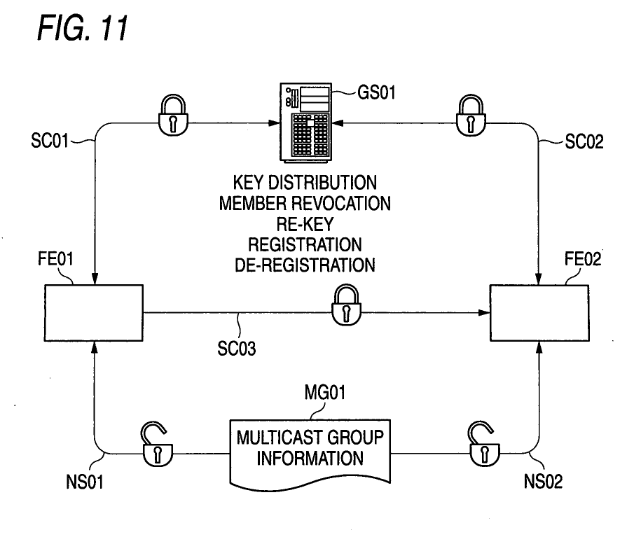

### DETAILED DESCRIPTION OF EXEMPLARY EMBODIMENTS

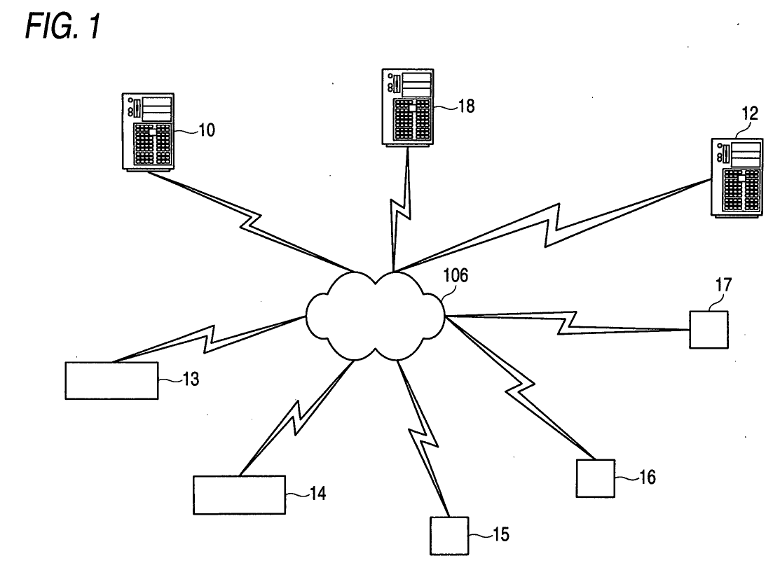

Exemplary embodiments will be explained in detail with reference to the drawings hereinafter. FIG. 1 is a configurative block diagram showing an embodiment of a control system according to the present invention.

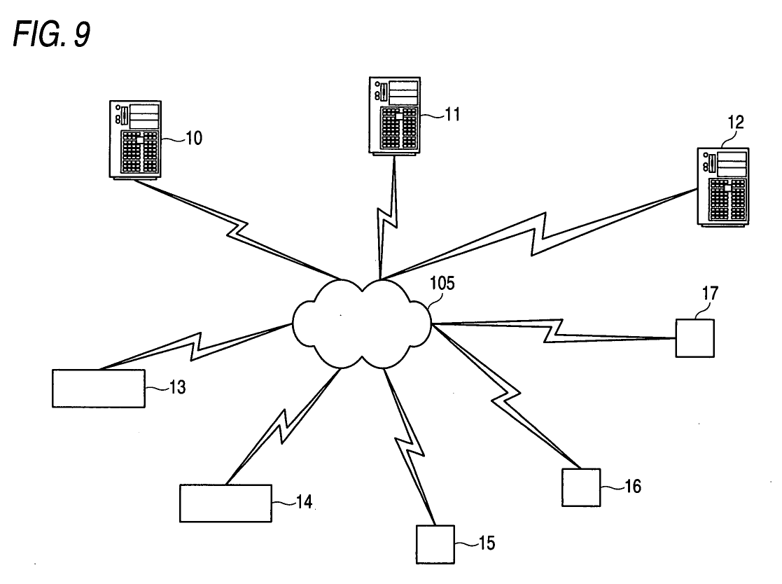

In FIG. 1, numerals 10, 12, 13, 14, 15, 16, and 17 denote the same elements as those in FIG. 9. A numeral 18 denotes an attribute server for managing/providing attribute information (identifier, IP address, etc.) necessary for the mutual authentication between the field equipments, and a numeral 106 denotes an IP network. Also, this attribute server 18 contains the preset “Multicast group information” such as the IP multicast address, and the like as the group information necessary for the multicast communication in the particular multicast group, and has a GGCKS server function.

The key management server 10, the attribute server 18, and the DHCP server 12 are connected mutually to the IP network 106. Also, the controllers 13 and 14 and the field equipments 15, 16, and 17 are connected mutually to the IP network 106.

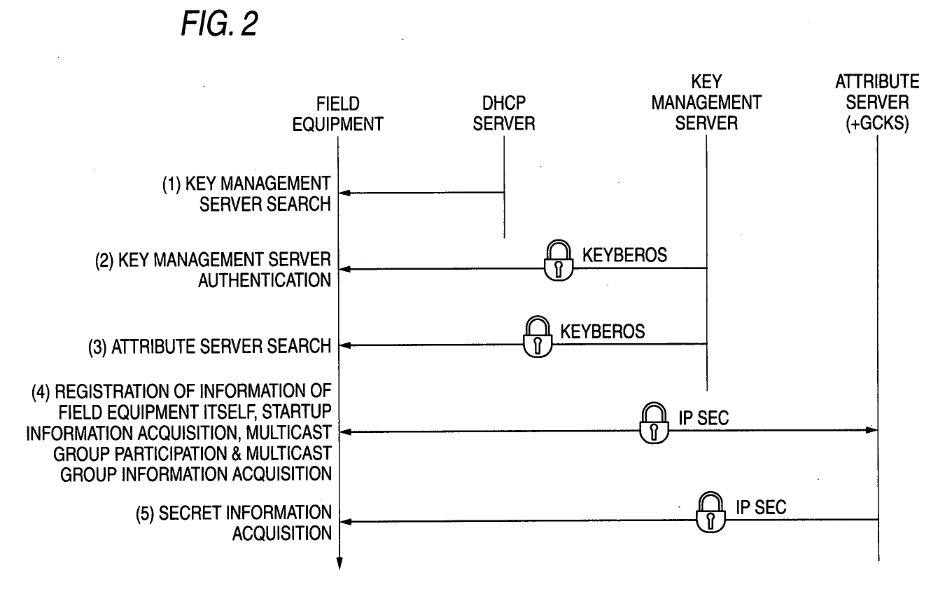

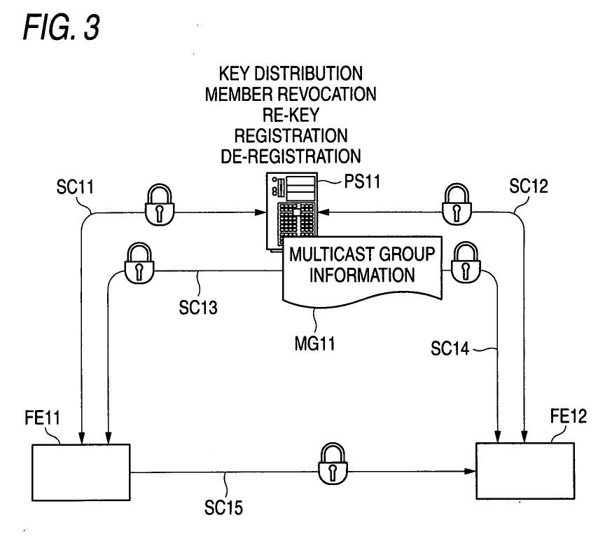

Next, an operation of the embodiment shown in FIG. 1 will be explained with reference to FIG. 2 and FIG. 3 hereunder. FIG. 2 is an explanatory view explaining a secure starting sequence of the field equipment, and FIG. 3 is an explanatory view explaining a secure multicast communication. Here, a symbol “locked lock” is affixed to the security communication.

The started field equipment (e.g., the field equipment 15) at (1) in FIG. 2 searches the information such as an identifier, an IP address, or the like of the key management server 10 existing on the IP network 106 from the DHCP server 12 to acquire the information.

Then, at (2) in FIG. 2, the field equipment 15 performs authentication of the key management server 10 using the acquired information such as the identifier, the IP address, or the like of the key management server 10. Also, at (3) in FIG. 2, this field equipment 15 searches the information such as an identifier, an IP address, or the like of the attribute server 18 existing on the IP network 106 to acquire the information.

Here, the communication at (2) in FIG. 2 and at (3) in FIG. 2 is the security communication secured by the Kerberos authentication. In order to clarify that the communication is held as the security communication, a symbol “locked lock” and characters “Kerberos” are affixed to the communications at (2) in FIG. 2 and at (3) in FIG. 2.

Also, at (4) in FIG. 2, the field equipment 15 registers information of the field equipment 15 itself such as the identifier, the IP address, or the like in the attribute server 18, acquires the necessary startup information from the attribute server 18, and receives a notification of “Multicast group information” such as the IP multicast address, and the like as the group information necessary for the multicast communication in the particular multicast group from the attribute server 18.

Also, at (4) in FIG. 2, the field equipment 15 participate in the particular multicast group using “Registration” of the attribute server 18 (concretely, the GCKS server function).

Also, at (5) in FIG. 2, the field equipment 15 receives a distribution of the secret information using “Key distribution” of the attribute server 18 (concretely, the GCKS server function).

Also, the communication at (4) in FIG. 2 and (5) in FIG. 2 is the security communication in which the packet is encrypted and authenticated based on IPsec (IP security). In order to clarify that the communication is held as the security communication, a symbol “locked lock” and characters “IPsec” are affixed to the communication at (4) in FIG. 2 and (5) in FIG. 2.

Meanwhile, the attribute server indicated by “PS11” in FIG. 3 has the GCKS server function. Also, this attribute server manages/provides the attribute information necessary for the mutual authentication between the field equipments, and also executes the control required for the secure multicast communication. This attribute server provides mainly five functions described above (their explanation will be omitted herein).

The field equipment indicated by “FE11” in FIG. 3 on the transmitter side participate in the particular multicast group using “Registration” in the attribute server (concretely, the GCKS server function) indicated by “PS11” in FIG. 3 through the security communication indicated by “SC11” in FIG. 3. Also, this field equipment receives a distribution of the secret information necessary to secure a secret of communication using “Key distribution” (referred simply to as “secret information” hereinafter).

Also, at this time, the field equipment indicated by “FE11” in FIG. 3 on the transmitter side receives a notification of “Multicast group information” indicated by “MG11” in FIG. 3 such as the IP multicast address, and the like as the group information necessary for the multicast communication in the particular multicast group from the attribute server (concretely, the GCKS server function) indicated by “PS11” in FIG. 3 through the security communication indicated by “SC13” in FIG. 3.

Meanwhile, the field equipment indicated by “FE12” in FIG. 3 on the receiver side receives the particular multicast group using “Registration” in the attribute server (GCKS server function) indicated by “PS11” in FIG. 3 through the security communication indicated by “SC12” in FIG. 3. Also, this field equipment receives a distribution of the secret information necessary to secure a secret of communication using “Key distribution” (referred simply to as “secret information” hereinafter).

Also, at this time, similarly the field equipment indicated by “FE12” in FIG. 3 on the transmitter side receives a notification of “Multicast group information” indicated by “MG11” in FIG. 3 such as the IP multicast address, and the like as the group information necessary for the multicast communication in the particular multicast group from the attribute server (concretely, the GCKS server function) indicated by “PS11” in FIG. 3 through the security communication indicated by “SC14” in FIG. 3.

Then, the field equipment indicated by “FE11” in FIG. 3 on the transmitter side sends the security communication using the secret information received by a distribution indicated by “SC15” in FIG. 3 to the acquired IP multicast address indicated by “MG11” in FIG. 3. Thus, this field equipment can establish the multicast communication with the field equipment indicated by “FE12” in FIG. 3 on the receiver side.

As a result, the attribute server 18 notifies the started field equipment of “Multicast group information” as the group information together with the startup information, and thus is able to set “Multicast group information” in the field equipment through the secure communication (IPsec). Also, the attribute server 18 controls the multicast communication by the GCKS server function that the attribute server has, and thus is able to hold the secure multicast communication by using the IP network.

In this case, in explaining the embodiment shown in FIG. 1, the DHCP server is provided to search the key management server 10. However the DHCP server is not the essential constituent element when the information on the identifier, the IP address, etc. of the key management server 10 are known in advance.

Also, in explaining the embodiment shown in FIG. 1, the multicast communication between the field equipments is explained by way of example. Of course, the present invention may be applied to the multicast communication between the controllers or between the controller and the field equipment.

Also, in explaining the embodiment shown in FIG. 1, the GCKS server function is provided to the attribute server 18. However, the GCKS server may be provided separately from the attribute server 18.

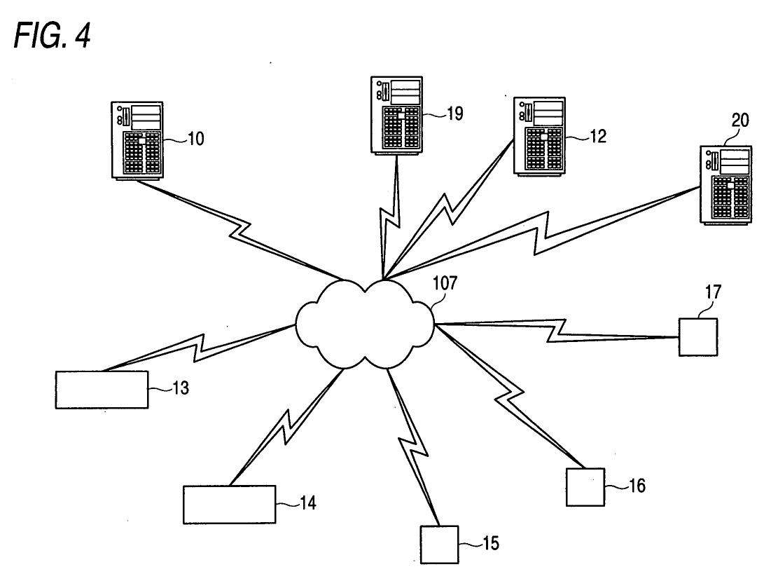

FIG. 4 is a configurative block diagram showing another embodiment of the control system according to the present invention. In FIG. 4, numerals 10, 12, 13, 14, 15, 16, and 17 denote the same elements as those in FIG. 1. A numeral 19 denotes an attribute server for managing/providing attribute information (identifier, IP address, etc.) necessary for the mutual authentication between the field equipments, a numeral 20 denotes a GCKS server, and a numeral 107 denotes an IP network. Also, this attribute server 19 contains the preset “Multicast group information” such as the IP multicast address, and the like as the group information necessary for the multicast communication in the particular multicast group.

The key management server 10, the attribute server 19, the DHCP server 12, and the GCKS server 20 are connected mutually to the IP network 107. Also, the controllers 13 and 14 and the field equipments 15, 16, and 17 are connected mutually to the IP network 107.

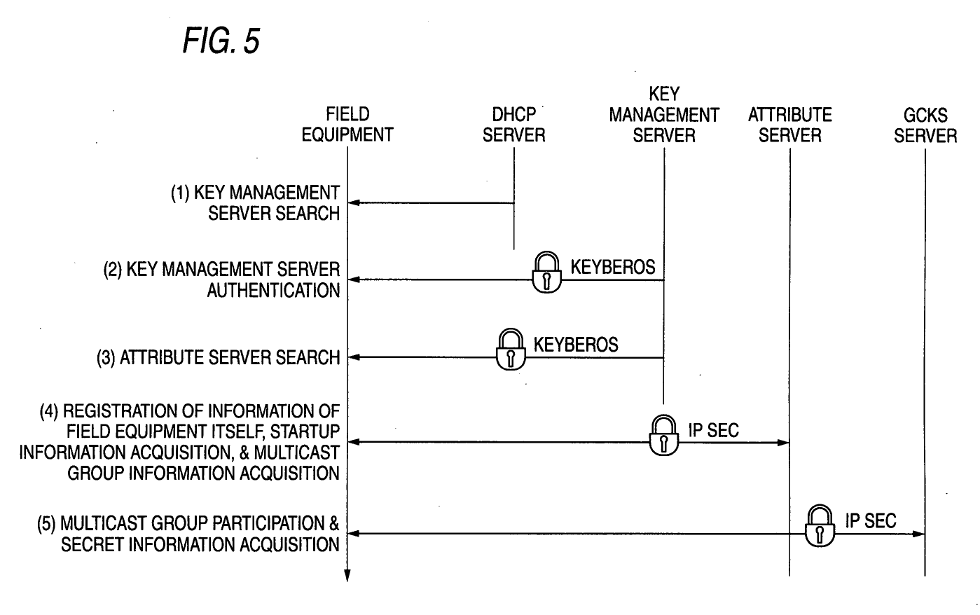

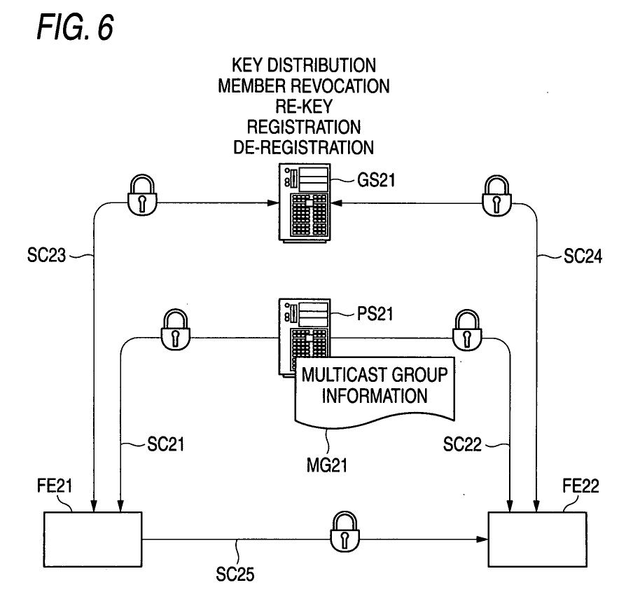

Next, an operation of the embodiment shown in FIG. 4 will be explained with reference to FIG. 5 and FIG. 6 hereunder. FIG. 5 is an explanatory view explaining the secure starting sequence of the field equipment, and FIG. 6 is an explanatory view explaining the secure multicast communication. Here, a symbol “locked lock” is affixed to the security communication.

The field equipment (e.g., the field equipment 15) started in (1) in FIG. 5 searches the information such as an identifier, an IP address, or the like of the key management server 10 existing on the IP network 107 from the DHCP server 12 to acquire the information.

Then, at (2) in FIG. 5, the field equipment 15 performs authentication of the key management server 10 using the acquired information such as the identifier, the IP address, or the like of the key management server 10. Also, at (3) in FIG. 2, this field equipment 15 searches the information such as an identifier, an IP address, or the like of the attribute server 18 existing on the IP network 107 to acquire the information.

Here, the communication at (2) in FIG. 5 and at (3) in FIG. 5 is the security communication secured by the Kerberos authentication. In order to clarify that the communication is held as the security communication, a symbol “locked lock” and characters “Kerberos” are affixed to the communications at (2) in FIG. 5 and at (3) in FIG. 5.

Also, at (4) in FIG. 5, the field equipment 15 registers information of the field equipment 15 itself such as the identifier, the IP address, or the like in the attribute server 19, acquires the necessary startup information from the attribute server 19, and receives a notification of “Multicast group information” such as the IP multicast address, and the like as the group information necessary for the multicast communication in the particular multicast group from the attribute server 19.

Also, at (5) in FIG. 2, the field equipment 15 participate in the particular multicast group using “Registration” of the GCKS server 20, and receives a distribution of the secret information using “Key distribution” of the GCKS server 20.

Also, the communication at (4) in FIG. 5 and (5) in FIG. 5 is the security communication in which the packet is encrypted and authenticated based on IPsec (IP security). In order to clarify that the communication is held as the security communication, a symbol “locked lock” and characters “IPsec” are affixed to the communication at (4) in FIG. 5 and (5) in FIG. 5.

Meanwhile, the attribute server indicated by “PS21” in FIG. 6 manages/provides the attribute information necessary for the mutual authentication between the field equipments, and also contains the previously set “Multicast group information” as the group information.

Also, the field equipment indicated by “FE21” in FIG. 6 on the transmitter side receives a notification of “Multicast group information” indicated by “MG21” in FIG. 6 such as the IP multicast address, and the like as the group information necessary for the multicast communication in the particular multicast group from the attribute server indicated by “PS21” in FIG. 6 through the security communication indicated by “SC21” in FIG. 6.

Also, the GCKS server indicated by “GS21” in FIG. 6 is the server that executes the control required for the secure multicast communication and provides mainly five functions described above (their explanation will be omitted herein).

The field equipment indicated by “FE21” in FIG. 6 on the transmitter side participate in the particular multicast group by using “Registration” in the GCKS server indicated by “GS21” in FIG. 6 through the security communication indicated by “SC23” in FIG. 6. Also, this field equipment receives a distribution of the secret information necessary to secure a secret of communication using “Key distribution” (referred simply to as “secret information” hereinafter).

Meanwhile, the field equipment indicated by “FE22” in FIG. 6 on the receiver side receives a notification of “Multicast group information” indicated by “MG21” in FIG. 6 such as the IP multicast address, and the like as the group information necessary for the multicast communication in the particular multicast group from the attribute server indicated by “PS21” in FIG. 6 through the security communication indicated by “SC22” in FIG. 6.

Also, the field equipment indicated by “FE22” in FIG. 6 on the receiver side participate in the particular multicast group using “Registration” in the GCKS server indicated by “GS21” in FIG. 6 through the security communication indicated by “SC24” in FIG. 6. Also, this field equipment receives a distribution of the secret information necessary to secure a secret of communication using “Key distribution” (referred simply to as “secret information” hereinafter).

Then, the field equipment indicated by “FE21” in FIG. 6 on the transmitter side sends the security communication using the secret information received by a distribution indicated by “SC25” in FIG. 6 to the acquired IP multicast address indicated by “MG21” in FIG. 6. Thus, this field equipment can establish the multicast communication with the field equipment indicated by “FE22” in FIG. 6 on the receiver side.

As a result, the attribute server 19 notifies the started field equipment of “Multicast group information” as the group information together with the startup information, and thus is able to set “Multicast group information” in the field equipment through the secure communication (IPsec). Also, the attribute server 19 controls the multicast communication by the GCKS server 20, and thus is able to hold the secure multicast communication by using the IP network.

While there has been described in connection with the exemplary embodiments of the present invention, it will be obvious to those skilled in the art that various changes and modification may be made therein without departing from the present invention. It is aimed, therefore, to cover in the appended claim all such changes and modifications as fall within the true spirit and scope of the present invention.

What is claimed is:

1. A control system comprising:
a plurality of field equipments that are connected mutually to an IP network;
a key management server that is connected mutually to the IP network and issues key information for authentication of the plurality of field equipments and security communication; and
an attribute server having a GCKS server function, which is connected mutually to the IP network, and manages or provides attribute information for mutual authentication between the field equipments, and contains preset group information for multicast communication in a particular multicast group, wherein
each of the field equipments is operable to:
a) make authentication of the key management server;
b) acquire information of the attribute server existing on the IP network;
c) register information of each of the field equipments itself in the attribute server;
d) acquire startup information from the attribute server;
e) receive a notification of the group information from the attribute server;
f) participate in a particular multicast group using the GCKS server function;
g) receive a distribution of secret information from the GCKS server function; and
h) perform multicast communication based on the group information and the secret information.

2. A control system comprising:
a plurality of field equipments that are connected mutually to an IP network;
a key management server that is connected mutually to the IP network and issues key information for authentication of the plurality of field equipments and security communication;
an attribute server that is connected mutually to the IP network, and manages or provides attribute information for mutual authentication between the field equipments, and contains preset group information for multicast communication in a particular multicast group; and
a GCKS server connected mutually to the IP network, wherein each of the field equipments is operable to:
a) perform authentication of the key management server;
b) acquire information of the attribute server existing on the IP network;
c) register information of each of the field equipments itself in the attribute server;
d) acquire startup information from the attribute server;
e) receive a notification of the group information from the attribute server;
f) participate in a particular multicast group using the GCKS server;
g) receive a distribution of secret information from the GCKS server; and
h) perform multicast communication based on the group information and the secret information.

3. The control system according to claim 1, wherein the multicast communication is performed between the field equipments, between controllers for controlling the field equipments, or between the field equipment and the controller.

4. The control system according to claim 2, wherein the multicast communication is performed between the field equipments, between controllers for controlling the field equipments, or between the field equipment and the controller.

5. A multicast communication method causing a field equipment to perform operations comprising:
a) performing authentication of a key management server;
b) acquiring information of an attribute server existing on an IP network;
c) registering information of the field equipment itself in the attribute server;
d) acquiring startup information from the attribute server;
e) receiving a notification of group information which is necessary for the multicast communication in a particular multicast group from the attribute server;
f) participating in the particular multicast group using a GCKS server function;
g) receiving a distribution of secret information from the GCKS server function, and
h) performing multicast communication based on the group information and the secret information.

6. A multicast communication method causing a field equipment to perform operations comprising:
a) performing authentication of a key management server;
b) acquiring information of an attribute server existing on an IP network;
c) registering information of the field equipment itself in an attribute server;
d) acquiring startup information from the attribute server;
e) receiving a notification of group information from the attribute server;
f) participating in a particular multicast group using a GCKS server;
g) receiving a distribution of secret information from the GCKS server; and
h) performing multicast communication based on the group information and the secret information.

7. The multicast communication method according to claim 5, wherein
the multicast communication is performed between the field equipments, between controllers for controlling the field equipments, or between the field equipment and the controller.

8. The multicast communication method according to claim 6, wherein
the multicast communication is performed between the field equipments, between controllers for controlling the field equipments, or between the field equipment and the controller.

9. A field equipment storing a program for executing a method comprising:
a) performing authentication of a key management server;
b) acquiring information of an attribute server existing on an IP network;
c) registering information of the field equipment itself in the attribute server;
d) acquiring startup information from the attribute server;
e) receiving a notification of group information which is necessary for the multicast communication in a particular multicast group from the attribute server;
f) participating in the particular multicast group using a GCKS server function;
g) receiving a distribution of secret information from the GCKS server function, and
h) performing multicast communication based on the group information and the secret information.
